(19) United States
(12) Patent Application Publication
(10) Pub. No.: US 2015/0269508 A1
(43) Pub. Date: Sep. 24, 2015

(54) Method And Apparatus For Configuring A Task List

(71) Applicant: McKesson Financial Holdings, Hamilton (BM)

(72) Inventors: Chanan Damboritz, Tel Aviv (IL); Eldon Allan Wong, Vancouver (CA); Itai Galili, Mevaseret Zion (IL); Laurie Bergeron, Langley (CA)

(73) Assignee: McKesson Financial Holdings, Hamilton (BM)

(21) Appl. No.: 14/217,896

(22) Filed: Mar. 18, 2014

(51) Int. Cl. G06Q 10/06; G06Q 50/22

(52) U.S. Cl. CPC G06Q 10/06311; G06Q 50/22

(57) ABSTRACT

A method, apparatus and computer program product are therefore provided in order to configure a task list. An example method may include providing a task list based at least in part on a configuration setting defined in a profile. The task list may include an indication of at least one task to be performed by a user in a clinical setting. The method may also include monitoring at least one user interaction with the task list, analyzing, using a processor, the at least one user interaction to detect at least one configuration change criterion, and causing a configuration change event in response to detecting the at least one configuration change criterion. The configuration change event may include a modification to the configuration defined in the profile.

### TECHNOLOGICAL FIELD

An example embodiment of the present invention relates generally to display of clinical task lists, and, more particularly, to a method and apparatus for configuring a task list based on monitored user interactions.

### BACKGROUND

Due to ever-increasing case loads, medical practitioners (e.g., doctors, nurses, physician's assistants, orderlies, technicians, and the like) may employ a variety of techniques to efficiently manage their schedule. Practitioners may be required to balance scheduled activities, such as rounds, reviewing non-urgent imaging studies, attending meetings, conducting peer reviews, teaching students, and the like, with unscheduled activities, such as reviewing urgent studies from emergency room patients, conducting emergency surgeries, responding to urgent consultation requests, and the like. Efficient management of practitioner workflows is important to ensure that tasks are properly prioritized.

Furthermore, practitioners may have different workflow preferences and needs. For example, a radiologist may review a particular imaging study in a different manner than a cardiologist or a neurologist, or a more experienced practitioner may require less oversight and peer review than a less experienced practitioner. A one-size-fits-all approach to task assignment and prioritization that fails to take into account these preferences may result in an inefficient workflow for some practitioners.

Through applied effort, ingenuity, and innovation, Applicant has solved many of these identified problems by developing a solution that is embodied by the present invention, which is described in detail below.

### BRIEF SUMMARY

A method, apparatus and computer program product are therefore provided according to an example embodiment of the present invention in order to provide for configuration of a clinical task list.

Embodiments may include methods, apparatuses, and computer readable storage media for configuring a task list. An example embodiment the method may include providing a task list based at least in part on a configuration setting defined in a profile. The task list may include an indication of at least one task to be performed by a user in a clinical setting. The method may also include monitoring at least one user interaction with the task list, analyzing, using a processor, the at least one user interaction to detect at least one configuration change criterion, and causing a configuration change event in response to detecting the at least one configuration change criterion. The configuration change event includes a modification to the configuration defined in the profile. The configuration change event may include prompting a user to confirm the modification to the configuration associated prior to modifying the configuration. The at least one user interaction may include at least one of marking a task as completed, assigning the task to another user, allowing the task to remain uncompleted, or accessing a folder associated with a task. The at least one configuration change criterion may include at least one of accessing a folder greater than a threshold number of times or reassigning a task to a particular user greater than a threshold number of times. The method may also include monitoring a plurality of user interactions and a plurality of configuration settings associated with a plurality of users, determining a set of user interaction analytics based on the plurality of user interactions, determining at least one correlation between the plurality of configuration settings and the plurality of user interactions, and recommending at least one configuration setting modification based on the determined at least one correlation.

In some embodiments, the method may also include identifying at least one user as a preferred user. The at least one user interaction may be performed by the preferred user, and the profile modified by the configuration change event may be associated with another user other than the preferred user. In some embodiments the modification to the configuration may include modifying a visual effect applied to a task in the task list. The modification to the configuration may also include adding an interface control to the task list. The interface control may perform at least one task selected from the group of reassigning a task or accessing a folder.

Additional embodiments may include an apparatus. The apparatus may include processing circuitry configured to cause the apparatus to provide a task list based at least in part on a configuration setting defined in a profile. The task list may include an indication of at least one task to be performed by a user in a clinical setting. The processing circuitry may further cause the apparatus to monitor at least one user interaction with the task list, to analyze the at least one user interaction to detect at least one configuration change criterion, and to cause a configuration change event in response to detecting the at least one configuration change criterion. The configuration change event may include a modification to the configuration defined in the profile. The processing circuitry may further configure the apparatus to monitor a plurality of user interactions and a plurality of configuration settings associated with a plurality of users, to determine a set of user interaction analytics based on the plurality of user interactions, to determine at least one correlation between the plurality of configuration settings and the plurality of user interactions, and to recommend at least one configuration setting modification based on the determined at least one correlation. In some embodiments, the processing circuitry may further configure the apparatus to identify at least one user as a preferred user, wherein the at least one user interaction is performed by the preferred user, and the profile modified by the configuration change event may be associated with another user other than the preferred user.

Embodiments may also provide a computer program product comprising at least one non-transitory computer-readable storage medium bearing computer program instructions embodied therein for use with a computer. The computer program instructions may include program instructions configured to provide a task list based at least in part on a configuration setting defined in a profile. The task list may include an indication of at least one task to be performed by a user in a clinical setting. The computer program instructions may further include program instructions configured to monitor at least one user interaction with the task list, to analyze the at least one user interaction to detect at least one configuration change criterion, and to cause a configuration change event in response to detecting the at least one configuration change criterion. The configuration change event may include a modification to the configuration defined in the profile. The configuration change event may include prompting a user to confirm the modification to the configuration associated prior to modifying the configuration.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is a functional diagram depicting an example user device in communication with a task management device in accordance with example embodiments of the present invention;

FIG. 3 is a block diagram representing an example user profile in accordance with example embodiments of the present invention;

FIG. 4 is an illustration of an example interface for managing practitioner tasks in accordance with example embodiments of the present invention;

FIG. 5 is an illustration of an example interface for confirming a task list change in accordance with example embodiments of the present invention;

FIG. 6 is a flow diagram of an example method for prompting configuration changes in a task list based on user interactions in accordance with example embodiments of the present invention;

FIG. 7 is a flow diagram of an example method for configuring a task list to add a shortcut to another folder in accordance with embodiments of the present invention;

FIG. 8 is a flow diagram of an example method for configuring a task list to automatically reassign a task to another user in accordance with embodiments of the present invention;

FIG. 9 is a flow diagram of an example method for configuring a task list based on a task completion time in accordance with embodiments of the present invention;

FIG. 10 is a flow diagram of an example method for configuring a task list to manage a consultation request in accordance with embodiments of the present invention; and

FIG. 11 is a flow diagram of an example method for using task list analytics to provide configuration changes in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### INTRODUCTION AND DEFINITIONS

A method, apparatus and computer program product are provided in accordance with an example embodiment of the present invention in order to configure a clinical task list. In this regard, a method, apparatus and computer program product of an example embodiment may provide an interface allowing a user to view one or more assigned tasks. Tasks may be assigned manually or programmatically by a task management device. Tasks may be prioritized for the user according to a set of rules. Priority tasks may be displayed in a particular order (e.g., at the top of the list), displayed in a particular area of the display (e.g., a particular window for “urgent” tasks), indicated with a visual effect (e.g., highlighted in red or blinking in a particular color), or otherwise indicated to the user. The user's interactions with the task list may be monitored by a task list monitoring component in order to provide configuration changes to the task list. For example, rules for assigning and displaying tasks to the user may be modified based on the user's interactions. In this manner, embodiments provide for improved assignment and display of tasks to users, thereby increasing the efficiency of the user's selection and performance of tasks.

For the purposes of this application, the term “task list” should be understood to refer to an application or group of applications employed to manage tasks into a single list. Management of such tasks may include, but is not limited to, assignment of tasks to a particular user, group of users, or user role, altering a display of a particular task, reassigning of a task to another user (e.g., if the user has exceeded a time limit for performing a task), detecting and/or receiving a notification of completion of a task (e.g., receiving a notification from an imaging application that an imaging study has been completed), removing a task from a particular user upon task completion, changing task priority, assigning/reassigning a task, adding a value to a task, and the like.

The term “task” should be understood to refer to an activity performed or to be performed in a clinical setting. For example, a practitioner's tasks may include performing rounds, conducting a peer review of a study, conducting a review of a resident's study, attending a meeting, charting a case, or any other actions performed by a medical practitioner. Tasks may not necessarily be associated with a particular practitioner, and may instead be assigned to a group of practitioners or based on a role of one or more practitioners. For example, an “urgent” study may be assigned to multiple practitioners to ensure that the first available practitioner reviews the study, and the task may be removed from other practitioners' task lists when a first practitioner “claims” the study.

The term “medical practitioner” should be understood to refer to any individual employed or volunteering in a clinical setting, including, but not limited to, doctors, nurses, nurse practitioners, physician's assistants, orderlies, technicians, or the like.

The term “configuration change criteria” refers to an a set of circumstances that, when occurring within a monitored user interaction or set of monitored user interactions, cause a configuration change to be performed on a profile used to provide a task list. The configuration change may relate to how tasks are assigned based on the profile and/or how tasks are displayed based on the profile.

The term “configuration change event” refers to an event that relates to a programmatic change caused in a configuration of a particular profile and which occurs in response to detection of a configuration change criterion or criteria. A configuration change event may include prompting a user to confirm the programmatic configuration change, or the configuration change may be automatically implemented without a confirmation or could be implemented by an administrator on behave of the user and their behavior.

### Example Apparatus

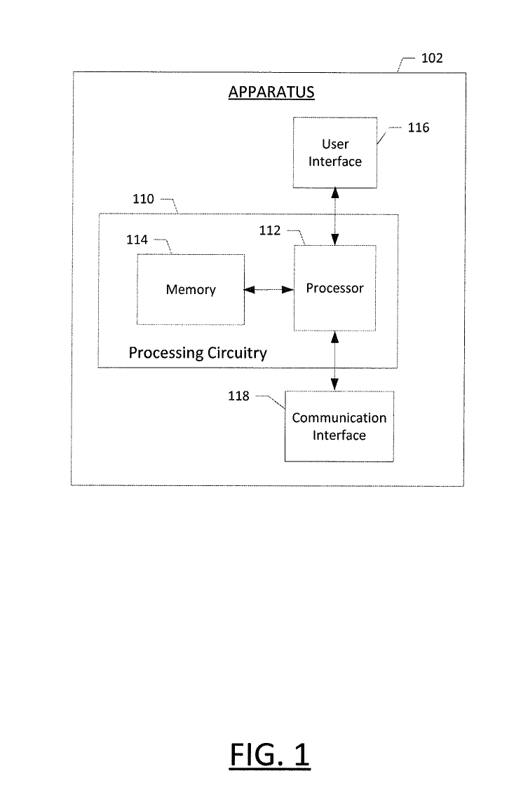

FIG. 1 illustrates a block diagram of an apparatus 102 in accordance with some example embodiments. The apparatus 102 may be any computing device capable of displaying and/or managing a task list as described herein. For example, the apparatus 102 may be implemented on a smart phone, personal digital assistant, tablet computer, netbook computer, laptop, server, or desktop. The apparatus 102 may be operable to display a task list to a user and to configure the display of the task list according to a configuration. The configuration may be dynamically determined based on the user's interactions with the task list. In some embodiments, a plurality of apparatuses (e.g., a client apparatus and a server apparatus) are employed to facilitate embodiments of the present invention, and each of these apparatuses may include functionality and structure as described with respect to the apparatus 102. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In some embodiments, the user interface 116 includes a touch screen input device for displaying a task list. Although described with respect to a touch screen, it should also be appreciated that the user interface 116 may be provided via other techniques, such as a display device in concert with a mouse, keyboard, joystick, touchpad, or the like.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the interne. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Example Task List Management Architecture

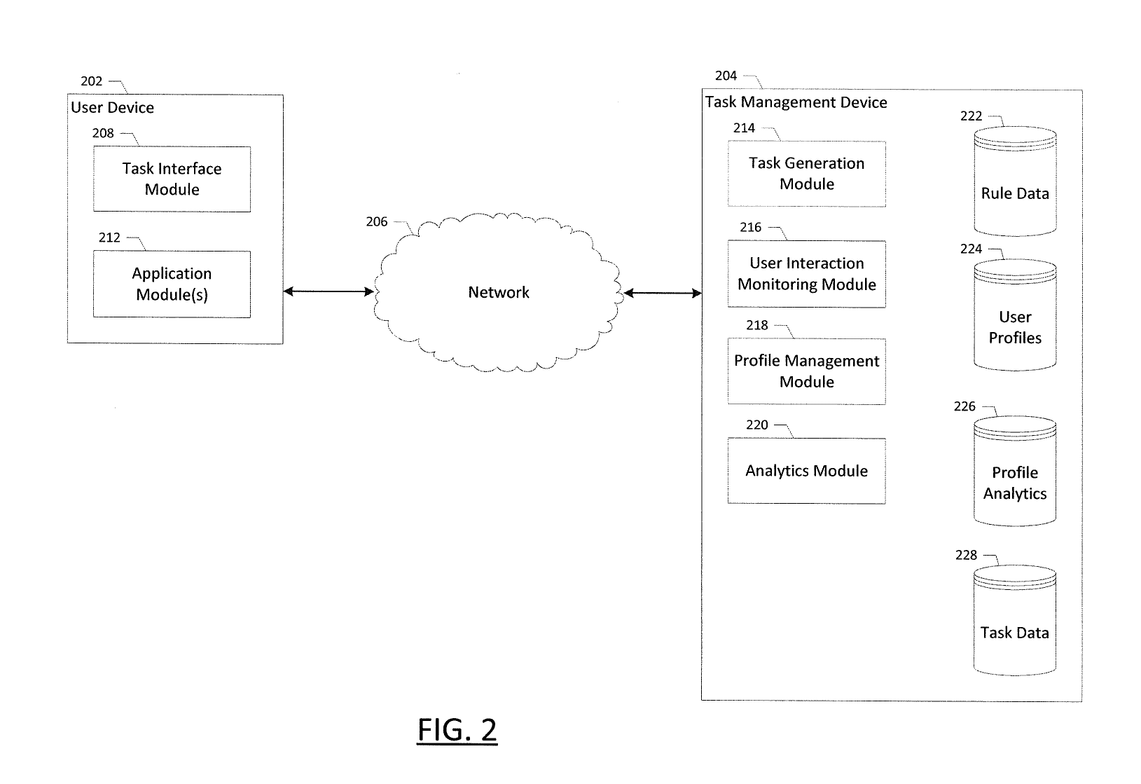

FIG. 2 is a block diagram of a task list management architecture 200 in accordance with example embodiments of the present invention. The illustration depicts a user device 202 in communication with a task management device 204 via a network 206. The user device 202 and the task management device 204 may be computing devices as known in the art, such as a smartphone, a laptop, a tablet computer, or the like. For example, the user device 202 and the task management device 204 may be apparatuses 102 as described above with respect to FIG. 1. Although the user device 202 and the task management device 204 are depicted as separate device with respect to FIG. 2, it should be appreciated that some embodiments may provide a single device performing the functions of both the user device 202 and the task management device 204.

The user device 202 may be any device capable of providing task information in a format that allows a user to view and/or otherwise interact with the task information. For example, the user device may be a laptop, desktop, tablet, or smartphone executing a task list application that receives task information and displays tasks to the user. To that end, the user device 202 may include a variety of hardware and/or software modules to facilitate providing the task information to the user. These modules may include a task interface module 208 and one or more application modules 212.

The task interface module 208 may be an application that operates to provide a list of tasks to the user. As described above, these tasks may correspond to various activities performed by a medical practitioner. Task assignments for the user may be received from the task management device 204 and displayed via the task interface module 208. For example, the task interface module 208 may provide for a user login to access a series of tasks managed by the task management device 204. Upon receiving the login information, the task management device 204 may send task information via the network to populate the task list displayed on the user device 202 by the task interface module 208. The task interface module 208 may provide for audio, video, and/or tactile feedback via a display, speakers, or other components of the user device 202 (not shown) to provide the task information to the user. The task interface module 208 may further receive user input to assist the user with obtaining and processing task information. For example, the user may interact with a particular task displayed in a list to obtain additional information about the task, such as the scheduled time for the task, the amount of time the task has been pending, another user that assigned the task, an application associated with the task, or the like. User interactions may further include indicating that the task has been performed (e.g., selecting a “complete” button associated with the task), launching an application associated with the task (e.g., where the task is “view a medical study”, selection of the task may launch a study viewer and/or open a file associated with the study), removing the task from the list, assigning the task to another practitioner, requesting assistance with the task (e.g., requesting a consult or peer review), obtaining reference material related to the task (e.g., providing a link to a teaching file or a medical atlas), creating a new related task (e.g., creating a task for a research action if a particular interpretation study is of research interest to the user), sharing a task with others, changing a task priority, assigning a task to a clinical trial space, indicating consent has been obtained from a clinical trial patient, or the like. The interactions provided to the task management device 204 may also include biographical information (e.g., the user's name, job title, specialty, or the like), temporal information (e.g., the time of day or the amount of time remaining in the user's shift), other involved users (e.g., a user to whom the task is being reassigned), or the like. The task interface module 208 may further monitor the user's interactions with the task list and transmit the interactions to the task management device 204 to assist with configuration of the task list and to derive task list analytics based on the interactions.

The application module(s) 212 may include other applications executing on the user device 202. These application module(s) 212 may include applications used to perform tasks provided in the task list. For example, the application module(s) 212 may include applications for viewing clinical studies, charting medical cases, accessing user e-mail, reviewing patient data, or any other application used to perform a task. In some embodiments, selection of a task from the task interface module 208 may cause the user device 202 to launch or open the particular application needed for the selected task. For example, selecting a task relating to review of a medical imaging study may open the study within a medical imaging viewer application.

The task management device 204 is operable to provide tasks and/or task information to the user device 202 and to receive task list interactions from the user device 202. The user interactions may be monitored to determine configuration changes to the task list. These configuration changes may be communicated to the user device 202 and stored in a profile configuration 210. To this end, the task management device 204 may comprise a plurality of hardware and/or software modules, such as a task generation module 214, a user interaction monitoring module 216, a profile management module 218, and an analytics module 220.

The task generation module 214 may identify tasks for association with a particular user or users and notify a corresponding user device of the task, so that the task may be displayed to the user by a task interface module 208. The task generation module 214 may generate and assign tasks based on data received by the task management device 204. For example, the task management generation module 214 may monitor incoming medical data, such as HL7 messages, to detect events that indicate a task should be generated. For example, an incoming message may indicate that a protocoling task should be created, or a Digital Imaging and Communications in Medicine (DICOM) import operation may cause creation of a medical image study task. In response, a task for reviewing the imaging study may be generated and assigned to a practitioner associated with the particular patient, a practitioner with the appropriate specialty, a practitioner on call at a particular time, a practitioner who has a highest efficiency rating for a particular task based on metrics or analytics, a practitioner with the lightest workload, a practitioner who is a designated subject matter expert, or the like. Additionally or alternatively, the task generation module 214 may provide an interface, via the task management device 204 or via a user device 202, for generating new tasks. For example, the interface may allow another practitioner to input task information for generation of a new task. Generated tasks may be stored as task data 228. The task data 228 may be updated, edited, deleted, and modified by the task generation module 214 in response to actions being taken on those tasks. For example, a task that is marked as completed by a user using a user device 202 may be marked as such in the task data 228 and removed from the user's task list, or a reassigned task may be associated with a different user by changing a user association for the task as stored in the task data 228.

The task generation module 214 may generate and assign tasks to practitioners or groups of practitioners according to a set of rules. In this manner, the task generation module 214 may function as a rule engine to process incoming medical data according to a set of specified rules and generate and assign tasks accordingly. These rules may be defined manually or programmatically, and stored on the task management device as rule data 222. The rule data 222 may include rules for how to process incoming messages to generate tasks, the content of tasks, to which users tasks should be assigned, and the like.

Rules may be defined in a markup language. For example, a set of rules assigning emergency room tasks to a user named “Dr. Moore” and displaying a notification on Dr. Moore′

TABLE 1
<RULE Name=”Assign ER MSK Tasks To Dr. Moore”>

<TRIGGER Type=”Incoming HL7 Message” />
<CRITERIA Expression=”[TOKEN1]”>
<CRITERION Token=”1”>StudyType=’ER MSK’</CRITERION>
</CRITERIA>
<ACTIONS>
<ACTION Type=”Create Task”>
<TASK>ER MSK</TASK>
<ASSIGNED_USER>Dr. Moore</ ASSIGNED_USER>
</ACTION>
<ACTION Type=”Popup”>
<TEXT>You have a new ER MSK Task</TEXT>
</ACTION>
</ACTIONS>

</RULE>

TABLE 2
Similarly, a set of rules that sends an e-mail to user “Dr. Super” when a
new task created could be implemented as follows:

<RULE Name=”Send Email To Dr. Super”>

<TRIGGER Type=”Task Creation” />
<CRITERIA />
<ACTIONS>

<ACTION Type=”Send Email”>

<TO>drsuper@physician.com</TO>
<SUBJECT>Task Created</SUBJECT>
<BODY>A new task was created</BODY>

</ACTION>

</ACTIONS>

</RULE>

TABLE 3
As yet another example, a set of rules that reassigns tasks from a user “Dr.
Cole” when the task has been assigned to user “Dr. Moore” for more than
5 minutes, where the tasks are also of a type “ER MSK” or “Outpatient
MSK” could be implemented as follows:
<RULE Name=”Re-assign Task To Dr. Cole”>

<TRIGGER Type=”Time Threshold Elapsed”>

<EPOCH_TYPE>Task Created</EPOCH_TYPE>
<THRESHOLD>5 min</THRESHOLD>

</TRIGGER>
<CRITERIA Expression=”[TOKEN1] AND ([TOKEN2] OR
[TOKEN3])”>

<CRITERION
Token=”1”>AssignedUser=’Dr. Moore’</CRITERION>
<CRITERION
Token=”2”>StudyType=’ER MSK’</CRITERION>
<CRITERION
Token=”3”>StudyType=’Outpatient MSK’</CRITERION>

</CRITERIA>
<ACTIONS>

<ACTION Type=”(Re)Assign Case”>
<USER>Dr. Cole</USER>
</ACTION>

</ACTIONS>

</RULE>

TABLE 4
As a final example, a set of rules that create a shared “ER Chest CT” Task
scan with a priority level of 1, when an CT exam study for the chest is
received in the ER could be implemented as follows:

<RULE Name=”Create ER Chest CT Task And Set Priority”>

<TRIGGER Type=”Incoming HL7 Message” />

<CRITERIA Expression”[TOKEN1] AND [TOKEN2]
AND

[TOKEN3]”>

<CRITERION Token=”1”>Modality=’CT’</CRITERION>
<CRITERION
Token=”2”>BodyRegion=’Chest’</CRITERION>
<CRITERION
Token=”3”>PatientLocation=’ER’</CRITERION>
</CRITERIA>

<ACTIONS>

<ACTION Type=”Create Task”>

<TASK>ER Chest CT</TASK>
<PRIORITY>1</PRIORITY>

</ACTION>

</ACTIONS>

</RULE>

The user interaction monitoring module 216 monitors user interactions with a task list. For example, as described above with respect to the user device 202, user interactions may include information such as how long the user takes to perform tasks (e.g., the amount of time between when the user receives the task and when the task is marked as completed, or the amount of time spent in a task-specific application performing the task), when the user performs tasks, which other users are involved in the user's tasks (e.g., to which other users the user frequently reassigns tasks), or the like. The user interaction monitoring module 216 may store information regarding these interactions in a set of user profile data 224.

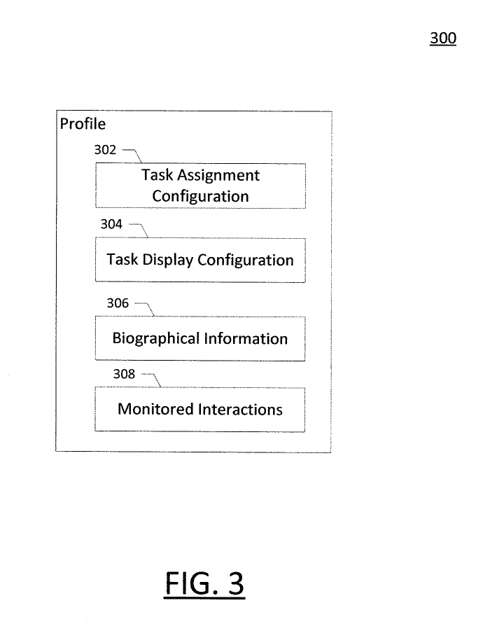

The user profile data 224 may include a set of rules and settings used to configure the task interface module 208. For example, the task interface module 208 may control the display of task information according to a set of rules defined within the user profile data 224. These rules may configure the way in which task information is provided to the user, such as altering the audible, visual, or tactile characteristics of a task list interface. For example, the user profile data 224 may include rules that configure the task interface module 208 such that an audible alert happens every time an urgent task is received, or particular tasks may be color coded based on the priority of the task, a user that assigned the task, the length of time the task has been on the user's task list, or the like. The user profile data 224 may also include additional rules that define interface controls. For example, particular practitioners may be identified as having use for certain shortcuts (e.g., access to certain folders, or hotkeys for reassigning tasks to a particular practitioner) based on their previous interactions. The user profile data 224 may provide rules to control the presence and operation of these interface controls. Although the user profile data 224 is generally described as related to a particular user, it should be appreciated that a given profile configuration may be associated with a group of users, a particular user role, a particular user device 202, or the like. The profile configuration may be received from a task management device 204, such as in response to the task management device 204 detecting certain task list interactions that indicate that particular configuration settings should be included in the user profile data 224. An example user profile is described further below with respect to FIG. 3.

A profile management module 218 may function to manage a particular user's task list experience. The profile management module 218 may facilitate alteration to a configuration associated with a particular user based on the monitored user interactions. The profile management module 218 may cause certain configuration changes in response to detection of certain configuration change criteria in the user's monitored interactions. For example, if a user frequently performs a particular interaction (e.g., accessing a particular folder or assigning cases to a particular practitioner), the profile management module may modify the user's profile to adjust the user's profile configuration to facilitate those tasks (e.g., by adding shortcuts or hotkeys). Detection of configuration change criteria may initiate a configuration change event, in which a configuration change is made for the user, or the user is prompted to indicate whether they would like to make the configuration change. Configuration change criteria may also be defined within the rule data 222. In some embodiments, the configuration change criteria may be programmatically determined, such as by correlating certain metrics with certain configuration settings using a machine learning algorithm (e.g., measuring the amount of time taken by practitioners or the accuracy of practitioners for a particular study type and correlating with particular settings for window size, gamma, and contrast for practitioners with faster times or higher accuracy rates).

An analytics module 220 may function to derive profile analytics 226 from monitored user interactions. The analytics module 220 may measure various metrics (e.g., length of time taken for a particular study type, frequency of tasks being overdue, frequency of task reassignment) and generate a set of analytics that detect correlations between the measured metrics and certain configuration settings. These correlations may be stored and used to derive rule data for use in altering profile configurations to improve performance. In some embodiments, the analytics module 220 may receive input for assisting with analytics. For example, certain practitioners may be identified as highly qualified, especially accurate, or otherwise a good source of “best practices,” and the analytics module may be configured to analyze the configuration settings of these practitioners to suggest configuration changes to other practitioners. The analytics module 220 may also be configured to generate reports of the settings employed by various practitioners and to provide these reports to users or other interested parties. The analytics module 220 may further generate elements of the rule data 222 to assist with generation of configuration change criteria to cause configuration change events for users.

### Example Profile

FIG. 3 depicts an example block diagram of a task list profile 300 in accordance with embodiments of the present invention. As described above, the profile 300 may be related to a particular user, a group of users, a particular user role (e.g., a “radiologist” role, or a “emergency room attending physician” role), or the like. The profile 300 may include configuration settings for configuring task lists for users that are associated with the profile. These configuration settings may include a task assignment configuration 302 and a task display configuration 304. The profile 300 may also include biographical information 306 for users, groups of users, user roles, or the like associated with the profile. The profile 300 may also include monitored task list interactions performed by users associated with the profile.

The task assignment configuration 302 may include data related to adding, removing, editing, and reassigning tasks to and from a particular user's task list. The task assignment configuration 302 may also include interface configuration data used for accessing task information, such as shortcut data, data defining interface controls, and the like. The task assignment configuration 302 may include configuration settings derived based on monitored user interactions, configuration settings defined by a user, or default configuration settings. The task assignment configuration 302 may further control how tasks are assigned priorities for the particular user. Additionally, the task assignment configuration 302 may include one or more settings for altering tasks. For example, the task assignment configuration 302 may include instructions that increase a task priority if the task has not been closed within a certain time period (e.g., the task has been open for more than 4 hours).

The task display configuration 304 may include data related to how tasks are communicated to users in an audible, visual, or tactile manner. For example, the task display configuration 304 may include instructions causing tasks to be displayed in a certain color, causing tasks to be displayed in a certain area of a display screen, causing an audible alert to occur upon task assignment, causing an audible alert upon a task being older than a certain threshold time, causing a user device to vibrate in response to a task being added, or the like. The task display configuration 304 may also include settings such as volume, contrast, gamma, or the like used to provide task data to the user. The task display configuration may further define which columns are displayed in the task list, the ordering of the columns, certain graphical flags and icons, or the like. While the task assignment configuration 302 may control which tasks are displayed, the task display configuration 304 may control how those tasks are displayed.

The task assignment configuration 302 and task display configuration 304 may be modified by a rules engine (e.g., the profile management engine 218 described with respect to FIG. 2) based on monitored interactions. These monitored interactions 308 may also be stored within the user profile for analysis and use in analytics. For example, the monitored interactions 308 may include data tracking user task selections, user task completions, the amount of time taken to complete tasks, to which users tasks are reassigned, and the like. The monitored interactions 308 may be analyzed by the rules engine to detect configuration change events. A configuration change event may initiate a change to the task assignment configuration 302 or the task display configuration 304. In some embodiments, a user may be prompted to confirm the change associated with the configuration change event. This prompt may include a brief description of the configuration change event and/or the rule that initiated the configuration change event. For example, a user may be presented with a prompt stating “You have previously opened this folder X times—would you like to add a shortcut to this folder on your interface?”

Some example configuration change events that may occur in response to various configuration change criterions are as follows:

Automatic Task Addition—In response to the configuration change criterion occurring, a task may be automatically added to the user's task list and a notification may be displayed. A notification may indicate that a task has been added.

Task Addition Confirmation—In response to the configuration change criterion occurring, a notification may be displayed asking the user to confirm an addition of a task to the user's task list, and the task may be added to the user's task list in response to selecting a confirmation dialogue.

Suggested Task—In response to the configuration change criterion occurring, a notification may provide information to the user about a particular task that is suggested for them. The user may decide to either add or ignore the task suggestion. If the user chooses to add the suggested task, the task is added to the user's task list.

Automatic Action Addition—In response to the configuration change criterion occurring, a target task for the user may automatically have a particular action added and a notification may be provided.

Confirm Action Addition—In response to the configuration change criterion occurring, a confirmation dialogue may be presented for adding a particular action to a target task.

Suggested Action—In response to the configuration change criterion occurring, a particular action for a particular task may be suggested to the user.

Suggested View—In response to the configuration change criterion occurring, a view for an imaging study task may be suggested to the user for a medical imaging task. For example, view suggestions may include separating the CT studies into different folders based on the patient location (e.g., one for ER patients, one for in-patients and one for out-patients), changing the location of a particular folder by moving it up in the a folder tree to reflect its higher important and usage, adding Image Count and Series Count columns to the task list for users that frequently view imaging studies, or the like.

Grouping/Organizing of tasks into a parent folder (for example, certain tasks may only be accessed by users of a particular type of Specialty □ The Specialty name could be suggested as a folder)

Service Level Agreement Notification—In response to detecting that the user is failing to meet the requirements of a service level agreement (e.g., certain studies must be reviewed within a certain period of time after receipt), then move studies in danger of failing the requirement to the top of the task list, or create a separate notification window for studies in danger of failing the requirement.

Teaching File Creation—In response to detecting that a particular case is frequently accessed, suggest creation of a teaching file or addition of the case to a teaching file for the particular user.

Patient Association—In response to detecting that the user has interacted with the same patient at least a threshold number of times, suggest adding a link to the records and/or studies associated with the particular patient.

The profile 300 may also include biographical information 306. The biographic information 306 may include information about the user or users to which the profile is associated. For example, the biographical information 306 may include user account credentials (e.g., a user name(s) and password), user access permissions (e.g., to which folders or patient medical records the user has access), user roles (e.g., medical specialty and/or sub-specialty), the user's assigned rotation (e.g., ER, surgery, radiology), or the like. In some embodiments, the profile is associated with a particular user role or a particular group of users, which may also be indicated by the biographical information 306.

### Example Interface

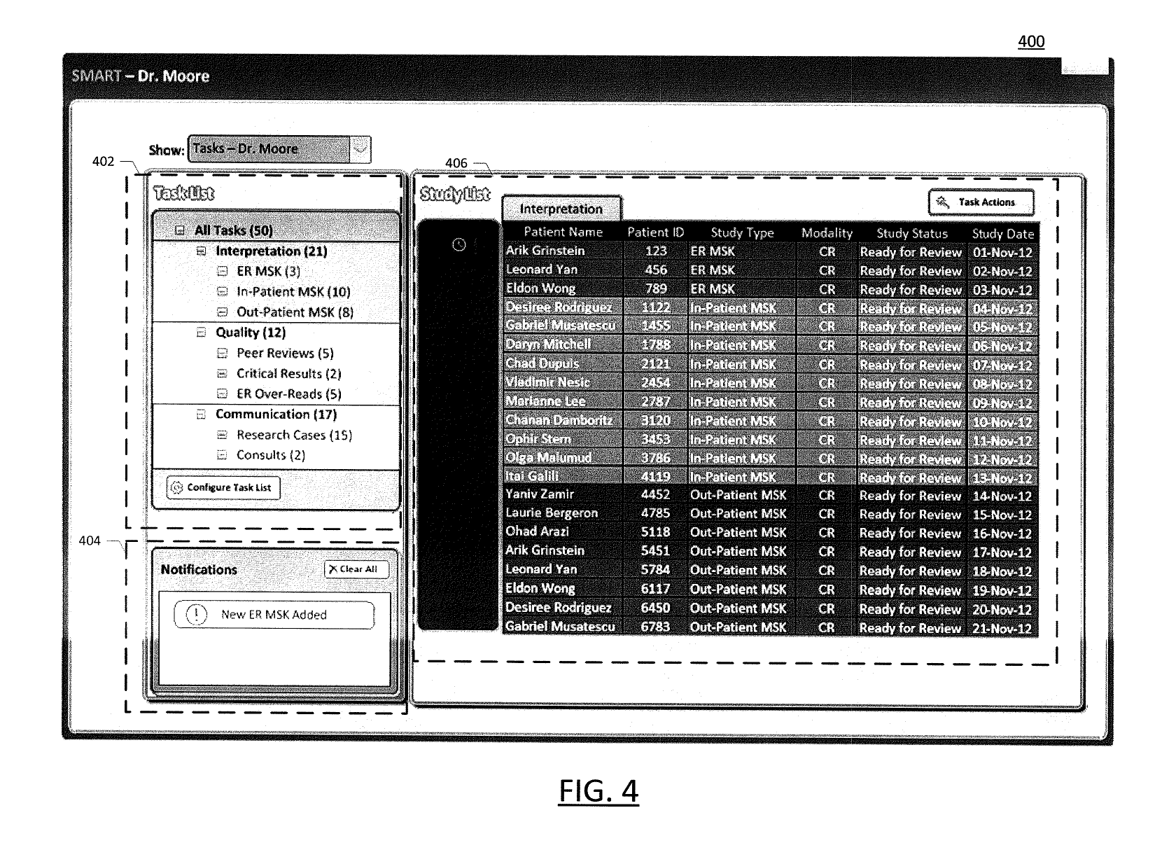

FIG. 4 depicts an example interface for providing a task list in accordance with embodiments of the present invention. The interface 400 depicts one example embodiment of a task list as displayed to a user, such as via an apparatus such as the user device 202 described with respect to FIG. 2, or an apparatus 102 as described with respect to FIG. 1. The interface 400 may be separated into a plurality of display areas, such as a task overview 402, a notification window 404, and a detailed task view 406. The interface 400 may be displayed on a display device, such as a monitor or touch-screen. User interactions with the interface 400 may be monitored, such as by monitoring mouse clicks, keyboard entries, touch-screen inputs, or the like.

The task overview 402 may display a breakdown of tasks associated with the user. For example, in the present illustration, the user has a total of 50 tasks, separated into three task types: interpretation, quality, and communication. Each of these task types has a further breakdown of particular task sub-types within the group. As tasks are assigned to the user, reassigned to other users, and completed, the task overview 402 may be updated to add newly assigned tasks and to remove completed or reassigned tasks. The user may select a particular task type or sub-type from the task overview 402 to view a detailed breakdown of the tasks of the selected type or subtype in the detailed task view 406. In the present example, the user has selected the “interpretation” task type, and the user's interpretation tasks are displayed in the detailed task view 406. Selection of a task from the detailed task view 406 (e.g., “tapping” the area of a touch screen corresponding to the task, or selecting a task with the mouse cursor) may launch an application associated with that task. For example, the interpretation tasks listed are musculoskeletal (MSK) studies, and selection of a task related to a particular study may launch an imaging application and open the corresponding study in the imaging application. Tasks may be listed in the detailed task view 406 in a particular order. In the present example, tasks are ordered according to whether the patient is an emergency room patient, an in-patient, or an out-patient. Tasks may also be ordered by time (e.g., with the oldest task listed first), to assist users with prioritization of tasks that have been pending for a longer period of time. The notification window 404 may be used to notify the user of events that occur with respect to their tasks, such as newly added tasks, reassigned tasks, configuration change events, and various other task-related notifications.

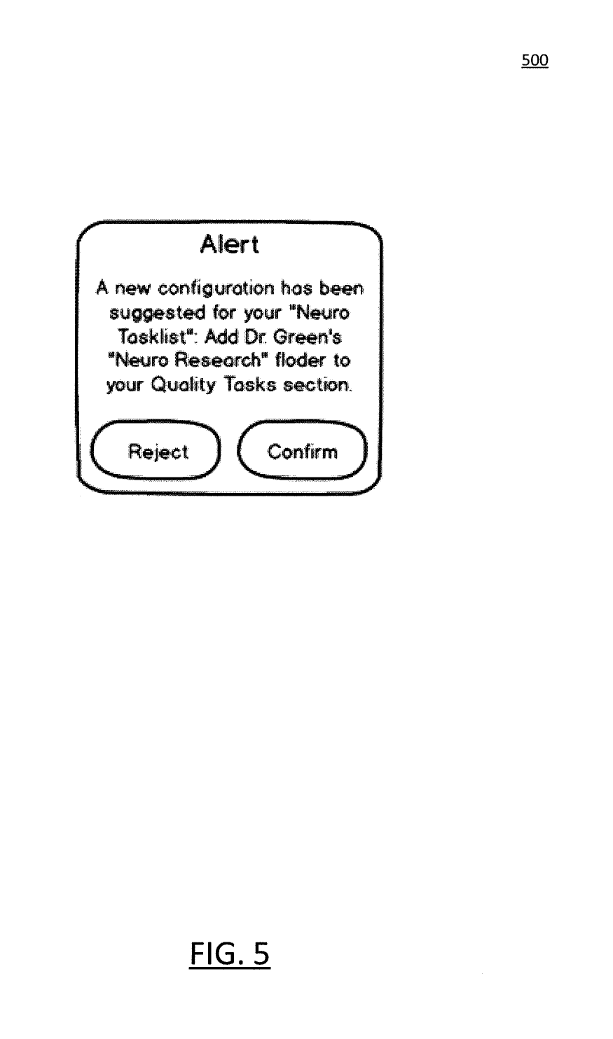

FIG. 5 depicts an illustration 500 of a confirmation window for modifying the configuration of a user task list in accordance with embodiments of the present invention. In the instant example, a configuration change is suggested for the user's “Neuro Task list” to add a research folder for another user, Dr. Green, to the user's task list. Such a change may be proposed in response to detection that the user frequently accesses Dr. Green's “Neuro Research” folder. Upon confirming the configuration change, the user's task list may be modified by having an interface control added that, when selected opens Dr. Green's “Neuro Research” folder, thus making accessing of said folder easier for the user.

### Example Process Flows

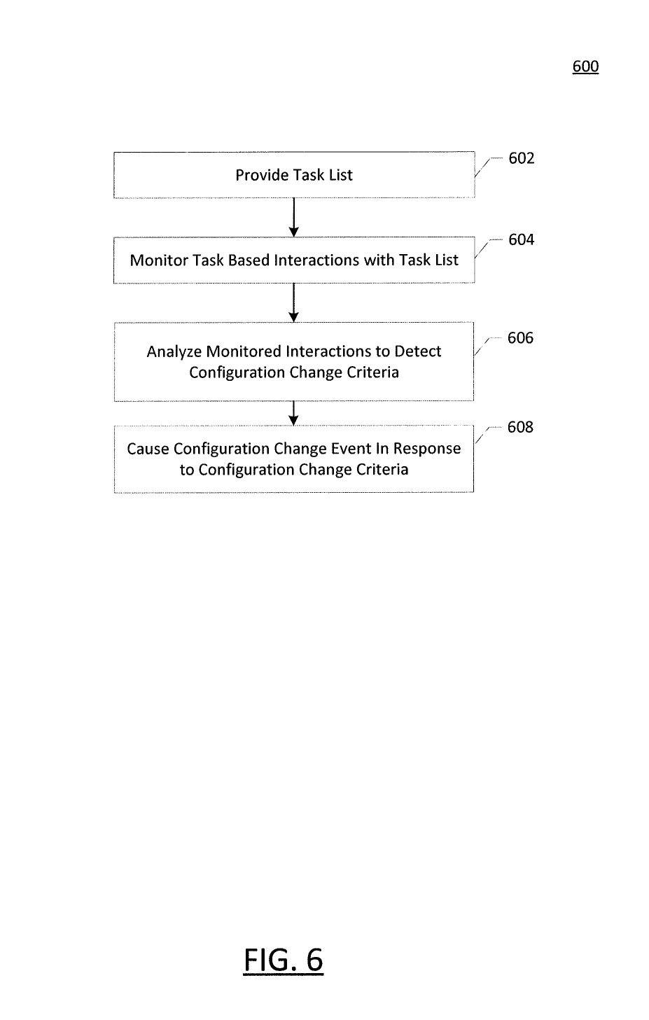

FIGS. 6-11 depict example process flows that may be employed to assist with configuration of a task list in accordance with example embodiments. These process flows describe how user interactions with a task list may be monitored to modify the configuration of the task list to improve future user interactions with the task list. These processes may be performed by a device, such as the apparatus 102 described with respect to FIG. 1, or the user device 202 or the task management device 204 described with respect to FIG. 2. The process flows may be used to program a processor or processing means as a special purpose computer to perform the described actions or to configure an apparatus to perform the described actions.

FIG. 6 depicts a flow diagram of a process 600 for initiating a configuration change based on monitored user interactions. At action 602, a task list is provided. The task list may be provided to a user, such as via a user device. As described with respect to FIG. 2, the task list may be dynamic in that tasks are automatically generated based on monitoring of health messages, such as HL7 messages. As tasks are generated, they may be assigned to users. When a task is assigned to a user, information relating to the task may be displayed in a task interface (e.g., the task interface 400 described with respect to FIG. 4) on the user device.

The user may interact with these tasks to mark the task as completed, to launch an application related to the task, to obtain additional information about the task, to reassign the task to another user, or the like. Such interactions may be monitored by the process at action 604. As the user interacts with the task list, the task list interactions may be stored and/or reported to a remote device, such as a task management device as described with respect to FIG. 2. In some embodiments, the monitored interactions may comprise messages sent between the user device and the task management device, such that the monitored interactions are the results of user inputs rather than the user inputs themselves. For example, rather than monitoring the screen position of a mouse cursor when the mouse is clicked, the monitored interactions may instead store the result of the mouse click, such as a task marked as completed, or a task is reassigned, such that a mapping between the user's input and the end result does not need to be performed during analysis of the user interactions. Alternatively, embodiments may track the actual input provided by the user (e.g., screen coordinates of touch inputs or cursor selections, keyboard key presses) which may be mapped to task list actions during analysis of the user interactions.

At action 606, the monitored interactions are analyzed to detect the presence of configuration change criteria. The configuration change criteria may comprise rules that are tied to particular configuration changes. For example, a configuration change criterion may relate to a user opening a particular file folder more than a threshold number of times. In response to detecting that the threshold has been met, a rule may be triggered suggesting a shortcut be added to the interface leading to the particular file folder. Such configuration change criteria may be manually defined, such as by a system administrator or supervisory user, or dynamically defined, such as by a machine learning algorithm.

In some embodiments, various methods and metrics may be utilized to identify and cause configuration changes. For example, different types of configuration changes could be assigned a classification for the degree to which a particular configuration change will impact the task list, such as the degree to which the change will affect task assignment or display of assigned tasks. Configuration changes that have a low impact (e.g., adding a link to a shared folder) may be more likely to be suggested than configuration changes with a higher impact (e.g., removal of a particular task type, organizing tasks into different display windows, reassignment of all tasks to another practitioner, or the like). In some embodiments, a calculation may be employed to weight the degree to which a configuration change is likely to improve a user's task list experience against the impact classification of the task, such that tasks with a large “reward” (e.g., a high likelihood of making the user's workflow more efficient) and a low “risk” (e.g., configuration changes that do not make significant changes to task assignment logic or task display) are more likely to be suggested to the user than tasks with a lower reward and greater risk. The impact and benefit of given configuration changes may be determined programmatically based on measured user interactions and/or analytics.

As an example of this process, a particular user may consistently exceed their budgeted time for a particular task type (e.g., emergency room MSK studies). As a result, tasks of this task type may be marked as a higher priority task. Another user may have a similar task load of tasks of the same task type, but not have any problem attending to the tasks within their budgeted time. Since the metric being used to identify a possible configuration change (e.g., budgeted time being exceeded) may be tied to a number of different factors, additional correlating metrics, such as the particular task type, may also be utilized to identify good candidate configuration changes. In the instant example, since both users are performing studies of the same type, configuration changes associated with the second user may be judged to have less of an impact and a greater likelihood of a reward for the first user, and thus the first user may have the configuration of the second user suggested as a possible configuration change. In another scenario, where the study types do not match, then a configuration change may be identified as having a higher possible impact (e.g., users of different specialties may require different configurations), and/or a lower possible reward (e.g., configuration changes that result in efficiency for a first specialty may not be efficient for a different specialty) and thus the system may not suggest the change.

At action 608, in response to detection of the configuration change criteria, a configuration change event may occur. The configuration change event may include prompting a user of the task list with the option to implement a configuration change based on the detected configuration change criteria. Alternatively, some embodiments may implement the configuration change event without prompting. The configuration change event may include making changes to one or more configuration settings associated with the user's profile. For example, a configuration file stored on a task management device may be altered and sent to the user device to reconfigure the user's task list to operate with the new configuration change, such as in the case where the configuration change modifies the user's task list interface by altering the display of the task list or adding, removing, of modifying an interface control of the task list interface. Alternatively or additionally, the configuration change may be implemented on the task management device, such as in the case where the configuration change relates to how tasks are generated and/or assigned to the user.

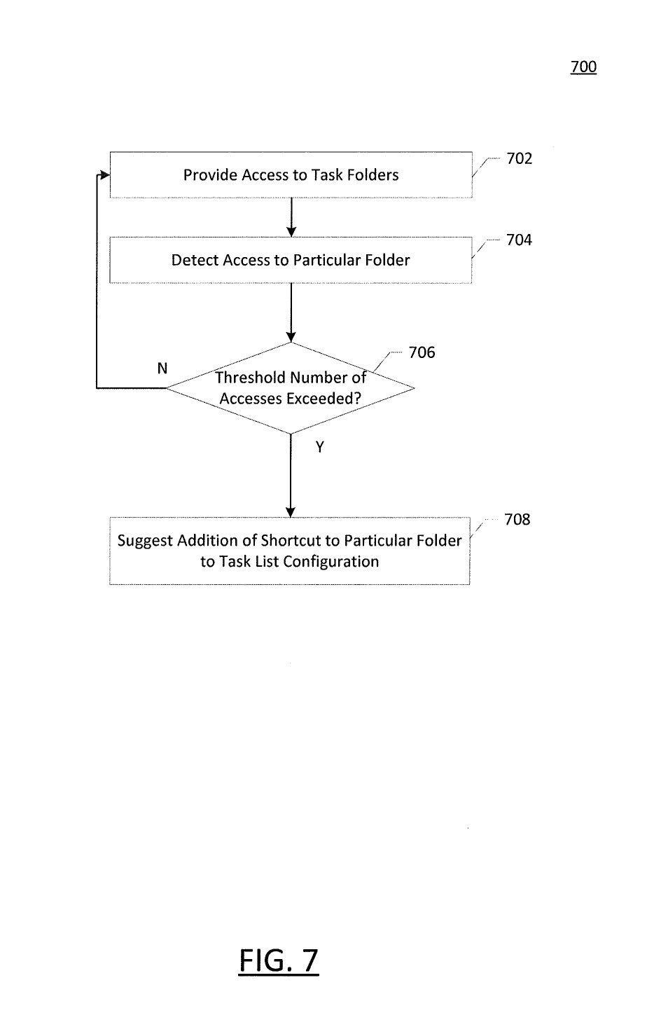

FIGS. 7-11 describe specific scenarios where particular user interactions may be monitored for configuration change criteria, and specific configuration change events caused in response to detecting the configuration change criteria. Although several examples of such criteria and events are given, it should be readily appreciated that various additional and alternative interactions could be monitored, and various additional and alternative configuration changes could be implemented based on detected criteria, and that these examples are not intended to limit the scope of the described configuration change process.

FIG. 7 depicts a flow diagram of a process 700 for performing a configuration change related to adding a folder shortcut interface control to a task list interface. The process 700 may be employed to improve the efficiency of a user's task list by adding shortcuts to frequently viewed folders, files, or the like. For example, clinical knowledge and experience varies across physicians within imaging departments, and it may be common for less experienced physicians to have their work checked by more experienced physicians. An experienced physician may thus frequently access a folder of studies assigned to a less experienced physician. The process 700 may improve the efficiency of the more experienced physician's task list interactions by monitoring his interactions to detect frequent access of the less experienced physician's folder. Upon detecting the frequent access, the process 700 may prompt the experienced user with an option to add a shortcut to the less experienced physician's folder on the more experienced user's task list interface. Similarly, a less experienced physician may frequently access a more experienced physician's completed research studies folder to improve their knowledge and learn from the more experienced physician's diagnoses. The process 700 may detect such frequent access by the less experienced physician and suggest adding a shortcut to the more experienced physician's folder on the less experienced physician's task list interface. Thus, accessing a particular folder a certain number of times may be used as a configuration change criterion, with an shortcut interface control being added as a configuration change event occurring in response to the configuration change criterion being met.

At action 702, the process 700 provides access to various folders, such as a set of clinical studies or a task folder. At action 704, the user accesses one of these folders (e.g., one physician accessing another physician's folder, as described above). This access may include traversing of several directory trees, or inputting login information to obtain access to the folder. Traversing the directory structure or inputting the same login information for a folder that is frequently accessed is inefficient due to the need to perform the same task repeatedly. The act of accessing the folder may be transmitted to a user interaction monitoring module, such as described above with respect to FIG. 2. Data transmitted to the user interaction monitoring module may include the folder being accessed, the identity of the owner of the folder, the time of the access, or any other information relevant to detecting configuration change criteria from the user's interactions with the task list. At action 706, a determination may be made as to whether the user has accessed the folder at least a threshold number of times. Accessing the folder at least the threshold number of times may be considered a configuration change criteria as described above with respect to FIGS. 2-3 and 5.

At action 708, the user may be prompted with a suggestion to add a shortcut to the accessed folder to their task list configuration in response to detecting that the folder has been accessed at least the threshold number of times. Otherwise, the method returns to action 702 to continue providing the task list. In this manner, the process 700 may detect a scenario that may result in increased efficiency of the task list interface (by saving the user from performing redundant actions when opening the same folder) based on monitoring of the user's interactions with the task list interface.

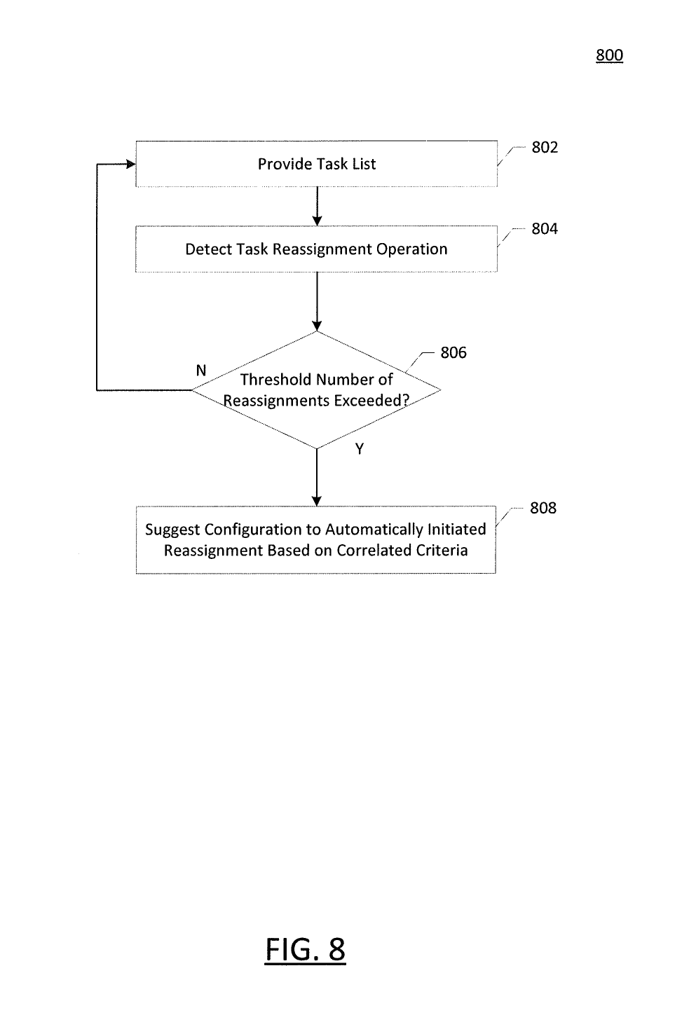

FIG. 8 depicts a flow diagram of a process 800 for automatic configuration of task assignments based on monitored user interactions in accordance with example embodiments. The process 800 may function to detect task reassignment operations that are frequently performed by a user, and, in response to detecting task reassignments being performed at a certain frequency, suggest configuring the user's task list for automatic reassignment of some tasks. Some workflows may be defined by user schedules and personal preferences. The process 800 may detect these workflows and suggest configuration changes to improve the efficiency of these workflows. For example, two users may be covering a particular imaging department (e.g., emergency room musculoskeletal imaging studies). The first user may frequently assign any remaining (e.g., unread or unreviewed) studies to the second user at the end of the first user's shift (e.g., at 5 pm). The process 800 may detect these frequent reassignment operations and suggest a configuration change that automatically reassigns any remaining studies to the second user when the first user logs out. Alternately, some embodiments may detect that the reassignment operations happen at the same time every day (e.g., 5 pm), and suggest a configuration change that triggers the automatic assignment at 5 pm. As a result, the first user does not need to manually reassign each task at the end of their day, thus saving the user time. Thus, reassigning a task a certain number of times (or correlated with another factor, such as the time of day) may be employed as a configuration change criterion, and implementing a configuration change to automatically reassign certain tasks may be a configuration change event.

At action 802, the task list may be provided to a user as described above. At action 804, a task reassignment operation is detected. At the time of the task reassignment, a notification may be sent to a user interaction monitoring module such as described above with respect to FIG. 2 to facilitate tracking of the reassignment. Information provided to the user interaction monitoring module may include the type of task being reassigned, the time of the reassignment, the user to which the task is reassigned, or any other information relevant to detecting configuration change criteria from the user's interactions with the task list. At action 806, a determination is made as to whether the number of reassignments exceeds a certain threshold. It should be appreciated that although the instant example is provided with respect to a threshold number of reassignments, various additional or alternative criteria may also be detected. For example, implementation of a configuration change may require both a threshold number of assignments and a correlation with a particular user, a particular time of day, the user's schedule, or the like. In response to detecting that the criteria has been met, a configuration change may be proposed to automatically initiate a reassignment of certain tasks (e.g., tasks of the same type) when the same criteria (e.g., the same correlation identified at action 806, such as a correlation with a particular time of day) are met. Otherwise, the method returns to action 802 to continue to provide the task list. In this manner, the process 800 may provide for increased efficiency for task list interactions by detecting frequent reassignments and proposing automatic reassignments based on criteria correlated with the user's past reassignments, thus saving the user time.

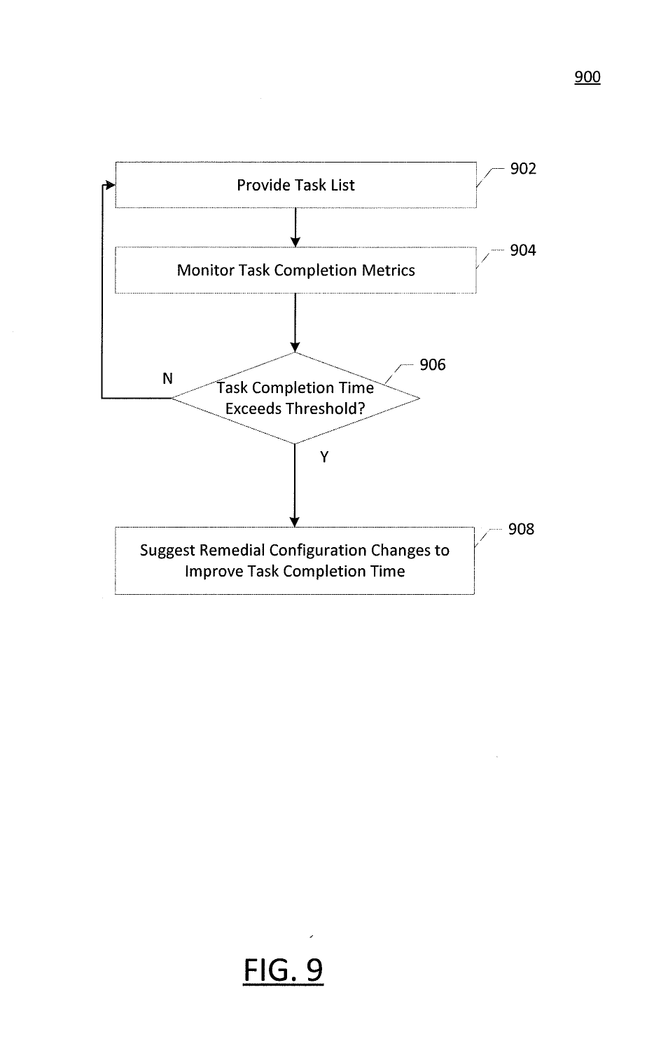

FIG. 9 depicts a flow diagram of a process 900 for performing a configuration change based on the length of time taken by a user to complete certain tasks. The process 900 may monitor the length of time certain tasks are pending for a user and suggest configuration changes to ensure the user properly prioritizes certain tasks. For example, a particular medical group may have a service level agreement with a hospital that all imaging studies originating from the hospital emergency room must be reviewed within 15 minutes. If a practitioner frequently takes more than 15 minutes to review a certain type of study, then cases may be escalated to other practitioners and the medical group may have penalties imposed for failing to meet their service level agreements. As such, the process 900 may monitor the length of time taken for reviewing different types of studies. If the process 900 detects that a particular user is frequently missing the 15 minute timer for a particular type of study, the process 900 may suggest a configuration change to automatically route that particular type of study to a different practitioner who has better metrics for the particular study type, or studies of that type may be immediately and clearly identified (e.g., with a flashing icon or special display window) for the user who frequently misses the timer so that the user can immediately begin work on such studies as they arrive. Thus, missing a timer associated with a particular type of study may be employed as a configuration change criterion, and implementing a rule to route the particular type of study to a different physician or to clearly identify studies of the problem type may be employed as a configuration change event.

At action 902, the task list (e.g., a list of tasks including at least one of the problem study type) is provided. At action 904, completion metrics for the tasks in the task list are monitored. These completion metrics may be monitored by noting the amount of time taken by the user from when the task is added to the user's task list until when the task is marked “complete” by the user, or by the amount of time the user spends reviewing the task in an application associated with the task (e.g., an imaging application). At action 906, a determination is made as to whether the user's task completion time exceeds a threshold time (e.g., the time specified by a service level agreement related to the task). In some embodiments, the threshold may be programmatically determined based on a data value associated with a particular service level agreement, a particular task type, or the like. In some embodiments, the determination may be made based on exceeding the threshold at a certain frequency (e.g., at least 25%, 50%, or 90% of a particular study type exceeding the threshold) to ensure that a single anomalous time does not necessarily trigger a configuration change. If the criterion is met at action 906, the method proceeds to action 908 to recommend a remedial measure to improve the metric, such as highlighting tasks of the problem type to the user to assist with faster identification, or reassigning tasks of the problem type to another user who is able to meet the required completion metrics. If the criterion is not met, the method returns to action 902 to continue providing the task list. In this manner, the process 900 provides for automatic reconfiguration of a task list to improve efficiency and ensure that certain task metrics are met.

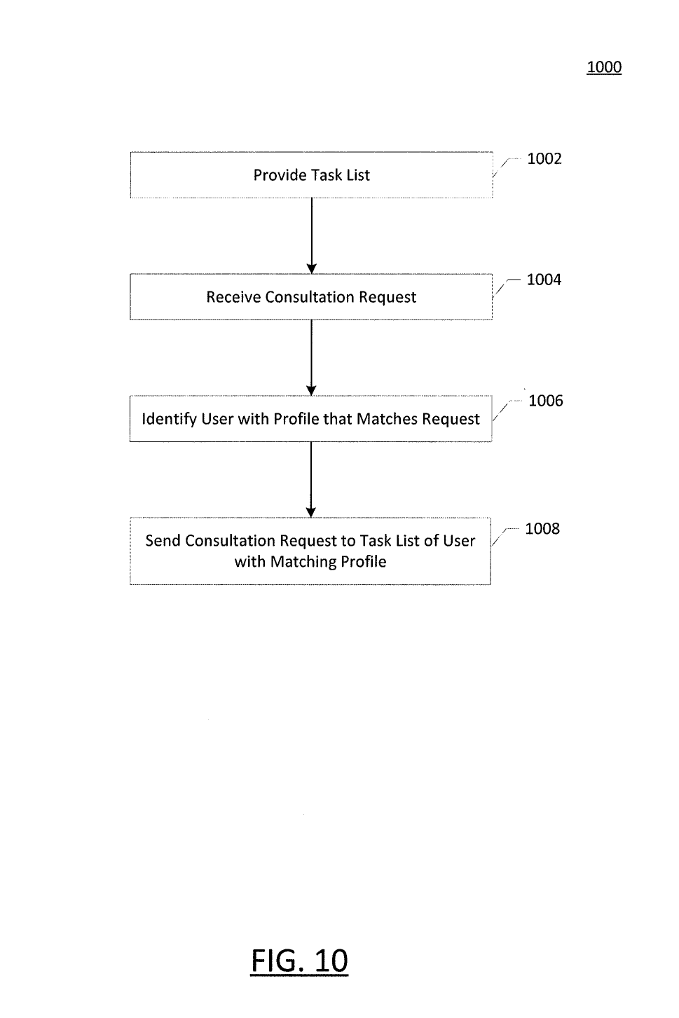

FIG. 10 depicts a flow diagram of a process 1000 for automatically determining an appropriate practitioner for reassigning a task to obtain a consultation in accordance with embodiments of the present invention. By monitoring user interactions with the task list and tracking user profile data (e.g., biographical information), embodiments may advantageously assist users with reassigning tasks or obtaining consultations from other users with similar interaction or biographical profiles. For example, the process 1000 may examine user profiles when a user requests a consultation on a particular task to assign a task to another user with similar profile characteristics (e.g., the same specialty, sub-specialty, and assigned rotation). In this manner, embodiments may improve the consultation process by automatically determining the best practitioner to receive the consult.

At action 1002, a task list is provided as described above. At action 1004, a consultation request is received for a particular task. For example, the user may select a “consultation request” interface control associated with the task. This interface control may trigger the task to be reassigned to another practitioner with a similar profile to the user. At action 71006, another user with a similar profile is identified. In some embodiments, the other user may be identified as a “best fit” based on all users who are available. The process 1000 may automatically determine the optimal user for the consultation based on parameters established by the requesting user when the consultation is requested. For example, the requesting user may specify a particular specialty, sub-specialty, rotation, or the like for the consultation. For example, a practitioner specializing in internal medicine may request a consultation from a cardiologist regarding a patient electrocardiograph study. At action 91008, the task may be reassigned to the user identified for the consultation, or a new “consultation” task may be generated and assigned to the user identified for the consultation, thus appearing on the identified user's task list.

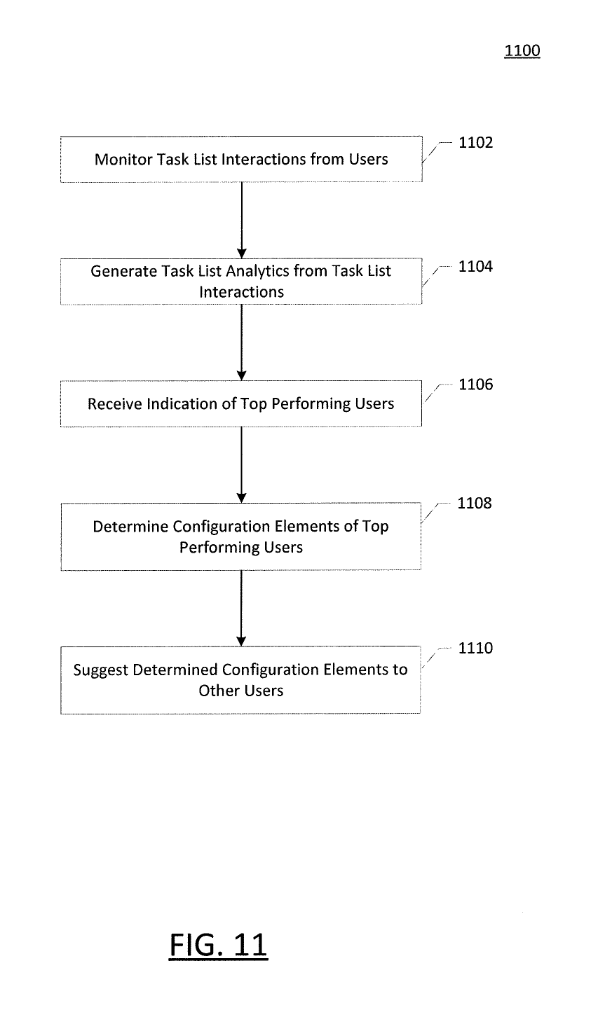

FIG. 11 depicts a flow diagram of a process 1100 for employing task list analytics to initiate configuration changes in a task list in accordance with some example embodiments. In some circumstances, monitored user interactions may be used to determine best practices that are used to implement configuration changes across user profiles. For example, monitored user interactions during certain tasks may be used to identify commonalities among the workflow of multiple practitioners to assist with modification of a “base” or “default” configuration, such that new users may have a configuration that is pre-populated with configuration settings identified to improve the user's experience. Additionally, certain users may be identified as particularly productive or frequently employing best practices. Embodiments of the method may function to analyze the workflows of these identified users to suggest configuration changes to other users in an effort to improve the productivity of the other users. In this manner, the monitored interactions of the preferred users may be employed to identify possible configuration changes that may be suggested to other users. In some embodiments, the process 1100 may also identify changes to the profile of the preferred user which may be manual or programmatically determined, and, in response to detecting a configuration change to the preferred user's profile, suggest the same changes to other users with similar characteristics (e.g., the same specialty or the like).

At action 1102, task list interactions from users are monitored. These task list interactions may be monitored across multiple users and aggregated for review by an analytics module, such as described above with respect to FIG. 2. At action 1104, a set of task list analytics may be generated from the monitored interactions. These task list analytics may indicate the amount of time spent by different practitioners for certain tasks, correlations between particular configuration settings and task completion metrics, overall productivity (e.g., number of tasks completed in a given time period) for different users, the number of relative value units (RVUs) generated by the practitioner, the average time allocation for interpretation, consult, or peer reviews within a particular department, the number of events that fail to meet a particular criteria (e.g., failures to meet quotas or time limits for particular tasks), the total task load at various times of the day, the applications or workflows most frequently accessed, or the like. At action 1106, an indication is received for users that are considered top performers. This indication may be received directly from a user (e.g., a user may indicate that Dr. A and Dr. B are the top performers based on information derived from an external source), or programmatically based on the analytics (e.g., identifying the practitioners with the highest productivity or the lowest time per task). At action 1108, the configuration settings for the identified top performers may be reviewed to identify commonalities across the configurations of the top performers. At action 1110, these common configuration settings may be suggested to other users as a configuration change event. It should be appreciated that some embodiments may not require explicit identification of top performers. Task metrics from the task analytics may be correlated with configuration settings across all practitioners, to attempt to identify which configuration settings are correlated with particular metrics. For example, rather than identifying configuration settings of top performers, embodiments may identify configuration settings that are correlated with lower metrics (e.g., longer task completion times), and suggesting to users to alter their configuration settings to avoid the settings correlated with the lower metrics. In this manner, embodiments may derive configuration changes from review of aggregated data in addition to review of particular top performing users.

In some embodiments, the analytics may be used to provide information to other users with similar profiles. Configuration changes may be suggested to other users based on the profiles of users with matching roles or other biographical information to allow users to benefit from configuration settings determined by other similar users. For example, a first user may have previously established a set of configuration settings to manage their personal tasks, and when a new user with the same specialty and rotation schedule registers with the system, the new user may be presented with the option to copy the settings from the first user.

As a particular example of this process, User A may be a radiologist that has a rotation schedule in the ER department, User B may be a resident that has a rotation schedule in the ER department, User C may be a radiologist that does not have a rotation schedule in the emergency room (ER) department, and User D may be a radiologist that has a rotation schedule in the ER department.

Users A-D may have task lists with the following entries: User A has a task defined for “ER MSK”. User B has a task defined for “Studies Of Interest”. User C has a task defined for “Consults”. User D has a task for “ER Research”.

Based on the information known about User A, User A might be associated with a profile for a radiologist (their medical specialty), a profile for an ER department rotation (their current rotation), or a combined profile for radiologists that are undergoing an ER department rotation. Profiles that match User A would thus include User B, who is a radiologist, User C, who is also on an ER rotation, and User D, who is both a radiologist and rotated to the ER.

Since User B is a resident as opposed to a radiologist, there is not a perfect overlap in the responsibilities and tasks for User B and User A. As such, since the disparity in profiles relates to a feature that is associated with the tasks and workflow (which will likely differ between a radiologist and a resident), configuration settings derived from User B may not be suggested to User A. As a result of analyzing the different profile matches, configuration setting changes may be proposed to User A such that User C's “Consults” configuration settings may be proposed to User A due to a match in the “Radiologist” specialty, and User D's “ER Research” configuration settings may be proposed to User A due to a match in both the “Radiologist” specialty and the “ER department” rotation.

It will be understood that each element of the flowcharts, and combinations of elements in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
providing a task list based at least in part on a configuration setting defined in a profile, the task list comprising an indication of at least one task to be performed by a user in a clinical setting;
monitoring at least one user interaction with the task list;
analyzing, using a processor, the at least one user interaction to detect at least one configuration change criterion; and
causing a configuration change event in response to detecting the at least one configuration change criterion, wherein the configuration change event comprises a modification to the configuration defined in the profile.

2. The method of claim 1, wherein the configuration change event comprises prompting a user to confirm the modification to the configuration associated prior to modifying the configuration.

3. The method of claim 1, wherein the at least one user interaction comprises at least one of marking a task as completed, assigning the task to another user, allowing the task to remain uncompleted, or accessing a folder associated with a task.

4. The method of claim 1, wherein the at least one configuration change criterion comprises at least one of accessing a folder greater than a threshold number of times or reassigning a task to a particular user greater than a threshold number of times.

5. The method of claim 1, further comprising:
monitoring a plurality of user interactions and a plurality of configuration settings associated with a plurality of users;
determining a set of user interaction analytics based on the plurality of user interactions;
determining at least one correlation between the plurality of configuration settings and the plurality of user interactions; and
recommending at least one configuration setting modification based on the determined at least one correlation.

6. The method of claim 1, further comprising identifying at least one user as a preferred user, wherein the at least one user interaction is performed by the preferred user, and wherein the profile modified by the configuration change event is associated with another user other than the preferred user.

7. The method of claim 1, wherein the modification to the configuration comprises modifying a visual effect applied to a task in the task list.

8. The method of claim 1, wherein the modification to the configuration comprises adding an interface control to the task list.

9. The method of claim 8, wherein the interface control performs at least one task selected from the group of reassigning a task or accessing a folder.

10. An apparatus comprising processing circuitry configured to cause the apparatus to:
provide a task list based at least in part on a configuration setting defined in a profile, the task list comprising an indication of at least one task to be performed by a user in a clinical setting;
monitor at least one user interaction with the task list;
analyze the at least one user interaction to detect at least one configuration change criterion; and
cause a configuration change event in response to detecting the at least one configuration change criterion, wherein the configuration change event comprises a modification to the configuration defined in the profile.

11. The apparatus of claim 10, wherein the configuration change event comprises prompting a user to confirm the modification to the configuration associated prior to modifying the configuration.

12. The apparatus of claim 10, wherein the at least one user interaction comprises at least one of marking a task as completed, assigning the task to another user, allowing the task to remain uncompleted, or accessing a folder associated with a task.

13. The apparatus of claim 10, wherein the at least one configuration change criterion comprises at least one of accessing a folder greater than a threshold number of times or reassigning a task to a particular user greater than a threshold number of times.

14. The apparatus of claim 10, wherein the processing circuitry further configures the apparatus to:
monitor a plurality of user interactions and a plurality of configuration settings associated with a plurality of users;
determine a set of user interaction analytics based on the plurality of user interactions;
determine at least one correlation between the plurality of configuration settings and the plurality of user interactions; and
recommend at least one configuration setting modification based on the determined at least one correlation.

15. The apparatus of claim 10, wherein the processing circuitry further configures the apparatus to identify at least one user as a preferred user, wherein the at least one user interaction is performed by the preferred user, and wherein the profile modified by the configuration change event is associated with another user other than the preferred user.

16. The apparatus of claim 10, wherein the modification to the configuration comprises modifying a visual effect applied to a task in the task list.

17. The apparatus of claim 10, wherein the modification to the configuration comprises adding an interface control to the task list.

18. The apparatus of claim 8, wherein the interface control performs at least one task selected from the group of reassigning a task or accessing a folder.

19. A computer program product comprising at least one non-transitory computer-readable storage medium bearing computer program instructions embodied therein for use with a computer, the computer program instructions comprising program instructions configured to:
provide a task list based at least in part on a configuration setting defined in a profile, the task list comprising an indication of at least one task to be performed by a user in a clinical setting;
monitor at least one user interaction with the task list;
analyze the at least one user interaction to detect at least one configuration change criterion; and
cause a configuration change event in response to detecting the at least one configuration change criterion, wherein the configuration change event comprises a modification to the configuration defined in the profile.

20. The computer program product of claim 19, wherein the configuration change event comprises prompting a user to confirm the modification to the configuration associated prior to modifying the configuration.
